(19) United States
(12) Patent Application Publication
(10) Pub. No.: US 2017/0149809 A1
(43) Pub. Date: May 25, 2017

(54) RECORDING MEDIUM, DECIDING METHOD, AND DECIDING APPARATUS

(71) Applicant: FUJITSU LIMITED, Kawasaki-shi (JP)

(72) Inventor: Masafumi Emura, Kawasaki-shi (JP)

(21) Appl. No.: 15/337,260

(22) Filed: Oct. 28, 2016

(30) Foreign Application Priority Data
Nov. 24, 2015 (JP) 2015-229172

(51) Int. Cl. H04L 29/06; H04L 12/26

(52) U.S. Cl. CPC H04L 63/1416; H04L 43/10; H04L 43/16; H04L 63/1425

(57) ABSTRACT

A non-transitory, computer-readable recording medium stores therein a deciding program that causes a computer to execute a process including storing connection information to a storage apparatus, the connection information including each of a plurality of connection timings, respectively, of a plurality of connections in communication between a terminal apparatus and a connection destination; calculating a plurality of connection intervals for each of the plurality of connections based on the connection information, the plurality of connection intervals being intervals of the plurality of connection timings with respect to previous connections, respectively; and deciding legitimacy of the connection destination based on the plurality of connection intervals.

### CROSS REFERENCE TO RELATED APPLICATIONS

This application is based upon and claims the benefit of priority of the prior Japanese Patent Application No. 2015-229172, filed on Nov. 24, 2015, the entire contents of which are incorporated herein by reference.

### FIELD

The embodiments discussed herein relate to a recording medium, a deciding method, and a deciding apparatus.

### BACKGROUND

Recently, security breaches consequent to advanced targeted attacks have increased. Under an advanced targeted attack, unauthorized access to an information technology (IT) system is difficult to prevent and security measures that assume unauthorized access are important.

For example, when a system is hacked, malware installed inside the system causes communication with a command and control (C&C) server used by the attacker to give commands. Therefore, an effective security measure detects and blocks communication from malware to a C&C server.

According to a related technique, for example, communication from a system to an external destination is monitored, and the communication counterpart is compared to a communication counterpart list of known C&C servers. According to another technique, HyperText Transfer Protocol (HTTP) requests are analyzed, a property value is calculated and whether the calculated property value is an abnormal value is judged based on a statistical amount that is based on the calculated property value. When the property value is an abnormal value, it is judged that the communication may be malicious. For example, refer to Japanese Laid-Open Patent Publication No. 2014-63424.

### SUMMARY

According to an aspect of an embodiment, a non-transitory, computer-readable recording medium stores therein a deciding program that causes a computer to execute a process that includes storing connection information to a storage apparatus, the connection information including each of a plurality of connection timings, respectively, of a plurality of connections in communication between a terminal apparatus and a connection destination; calculating a plurality of connection intervals for each of the plurality of connections based on the connection information, the plurality of connection intervals being intervals of the plurality of connection timings with respect to previous connections, respectively; and deciding legitimacy of the connection destination based on the plurality of connection intervals.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an example of a deciding method according to an embodiment;

FIG. 2 is a diagram depicting an example of system configuration of a system 200;

FIG. 3 is a block diagram depicting an example of hardware configuration of a deciding apparatus 100;

FIG. 4 is a block diagram depicting an example of hardware configuration of terminal apparatuses 201, etc.;

FIG. 5 is a diagram depicting a detailed example of connection information;

FIG. 6 is a diagram depicting one example of contents stored by a decision result DB 240;

FIG. 7 is a block diagram depicting an example of a functional configuration of the deciding apparatus 100;

FIG. 8 is a diagram depicting an example of a warning screen;

FIG. 9 is a diagram depicting an example of a list screen;

FIG. 10 is a flowchart depicting an example of a procedure of a first deciding process by the deciding apparatus 100; and

FIG. 11 is a flowchart depicting an example of a procedure of a second deciding process by the deciding apparatus 100.

### DESCRIPTION OF THE INVENTION

Embodiments of a deciding program, a deciding method, and a deciding apparatus will be described in detail with reference to the accompanying drawings.

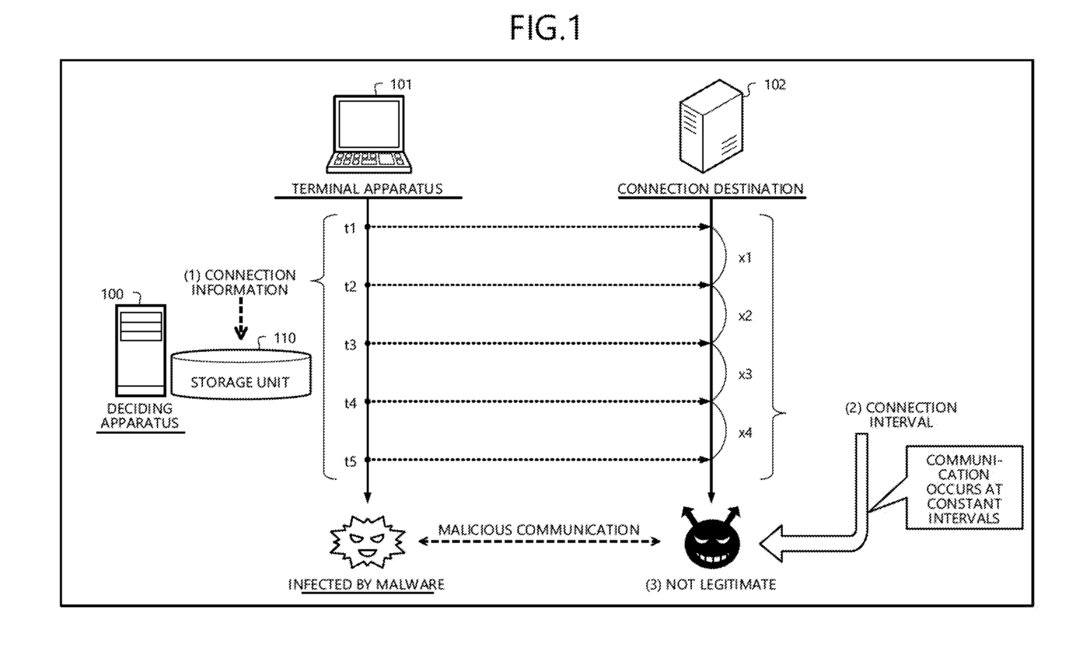

FIG. 1 is a diagram depicting an example of the deciding method according to the present embodiment. In FIG. 1, a deciding apparatus 100 is a computer configured to decide the legitimacy of a connection destination 102 that communicates with a terminal apparatus 101. The terminal apparatus 101 is a computer that communicates with the connection destination 102. The connection destination 102 is a computer that communicates with the terminal apparatus 101.

In particular, the terminal apparatus 101, for example, is a personal computer (PC), a server, etc. in a system of an organization that may be a target of an advanced targeted attack. An organization, for example, is a government agency, a public service authority, a company, etc. Further, the connection destination 102, for example, is an external PC, server, etc. outside the system that includes the terminal apparatus 101.

An advanced targeted attack is one type of advanced cyber-attack aimed at the information inside a particular organization. An advanced targeted attack, for example, begins by transmitting to an employee of an organization under attack, electronic mail carrying an attachment infected with a computer virus. The wording of the electronic mail, for example, often pertains to something that only employees of the organization would know, or is worded in such a way that an employee is likely to open it.

When the attached file is executed on the PC of an employee, the PC becomes infected by malware. Thus, when the system is hacked, communication between the malware in the system and an external C&C server begins. A C&C server is a server used by the attacker to send attack commands to malware infected computers.

Therefore, an effective security measure detects and blocks communication from malware inside a system to a C&C server. However, malicious communication from malware inside a system to a C&C server is difficult to distinguish from legitimate communication during web browsing. Therefore, for example, a method of monitoring communication from a system to an external counterpart and comparing the communication counterpart to a list of communication counterparts known to be C&C servers in order to detect communication from malware to a C&C server is conceivable.

However, with this method, communication to a C&C server not on the list (a so-called, blacklist) cannot be detected. Further, the Uniform Resource Locator (URL) of the C&C server is often repeatedly generated and deleted at short intervals (e.g., 24 hours), making the creation and maintenance of a valid list of C&C server URLs difficult.

Thus, at the initial stage from infection of malware until receipt of an instruction from the attacker, communication from malware to a C&C server often occurs mechanically at a constant interval. On the other hand, after the attacker has begun the attack, the possibility of communication from the malware to the C&C server occurring at a constant interval becomes lower compared to the initial stage.

Further, with communication during web browsing, communication from the system to an external counterpart rarely occurs at a constant interval. In other words, when communication from the system to an external counterpart occurs at substantially constant intervals, the communication has a high possibility of being malicious communication from the system to a C&C server.

Thus, in the present embodiment, a deciding method will be described that uses the tendency of communication to a C&C server occurring mechanically at a constant interval at the initial stage immediately after malware infection to decide the legitimacy of a connection destination and enable detection of a connection destination of malicious communication.

(1) The deciding apparatus 100 stores to the storage unit 110, pieces of connection information identifying each connection timing of multiple connections in communication between the terminal apparatus 101 and the connection destination 102. In particular, for example, when detecting communication from the terminal apparatus 101 to the connection destination 102, the deciding apparatus 100 stores to the storage unit 110, the connection information identifying the connection timing for the communication. In this case, the connection timing, for example, is expressed by the time at which the communication from the terminal apparatus 101 to the connection destination 102 is detected.

(2) For each connection in communication between the terminal apparatus 101 and the connection destination 102, the deciding apparatus 100 calculates connection intervals with respect to previous connections, based on the connection information stored in the storage unit 110. In the example depicted in FIG. 1, connection timings in the communication between the terminal apparatus 101 and the connection destination 102, identified from the connection information stored in the storage unit 110 are assumed to be “times t1 to t5”.

In this case, the deciding apparatus 100 calculates connection intervals x1 to x4, based on times t1 to t5. The connection interval x1 is a time interval between time t1 and time t2. The connection interval x2 is a time interval between time t2 and time t3. The connection interval x3 is a time interval between time t3 and time t4. The connection interval x4 is a time interval between time t4 and time t5.

(3) The deciding apparatus 100 decides the legitimacy of the connection destination 102, based on the calculated connection intervals. As described, when communication to a destination outside the system occurs at substantially constant intervals, the communication has a high possibility of being malicious communication from the system to a C&C server.

Therefore, for example, when variation of the calculated connection intervals is smaller than a predetermined reference, the deciding apparatus 100 decides that the connection destination is not legitimate. In particular, for example, the deciding apparatus 100 determines whether communication to the connection destination 102 is at constant intervals, based on the calculated connection intervals x1 to x4.

For example, the deciding apparatus 100 may determine that communication to the connection destination 102 is at constant intervals when a statistical value indicating the extent of variation of the connection intervals x1 to x4 is less than a predetermined value. Further, for example, the deciding apparatus 100 may determine that communication to the connection destination 102 is at constant intervals, when the difference of the largest value and the smallest value among the connection intervals x1 to x4 is of a predetermined range.

When the deciding apparatus 100 determines that communication to the connection destination 102 is at constant intervals, the deciding apparatus 100 decides that the connection destination 102 is not legitimate. On the other hand, when determining that the communication to the connection destination 102 is not at constant intervals, the deciding apparatus 100 decides that the connection destination 102 is legitimate. In the example depicted in FIG. 1, communication from the terminal apparatus 101 to the connection destination 102 is at substantially constant intervals. Therefore, the deciding apparatus 100 decides that the connection destination 102 is not legitimate.

In this manner, the deciding apparatus 100 decides the legitimacy of the connection destination 102 based on the connection interval of each connection in the communication between the terminal apparatus 101 and the connection destination 102. As a result, for example, it may be decided that the connection destination 102 performing communication with the terminal apparatus 101 at substantially constant intervals is not a legitimate connection destination.

Therefore, in the initial stage up until receipt of an instruction from the attacker, a connection destination of malicious communication such as a C&C server, which communicates with malware at constant intervals, may be detected. Further, even C&C servers not on a blacklist may be detected as a connection destination of malicious communication. When the deciding apparatus 100 decides that the connection destination 102 is not legitimate, the terminal apparatus 101 may be identified as a computer having a high possibility of being infected by malware.

A system 200 according to the present embodiment will be described.

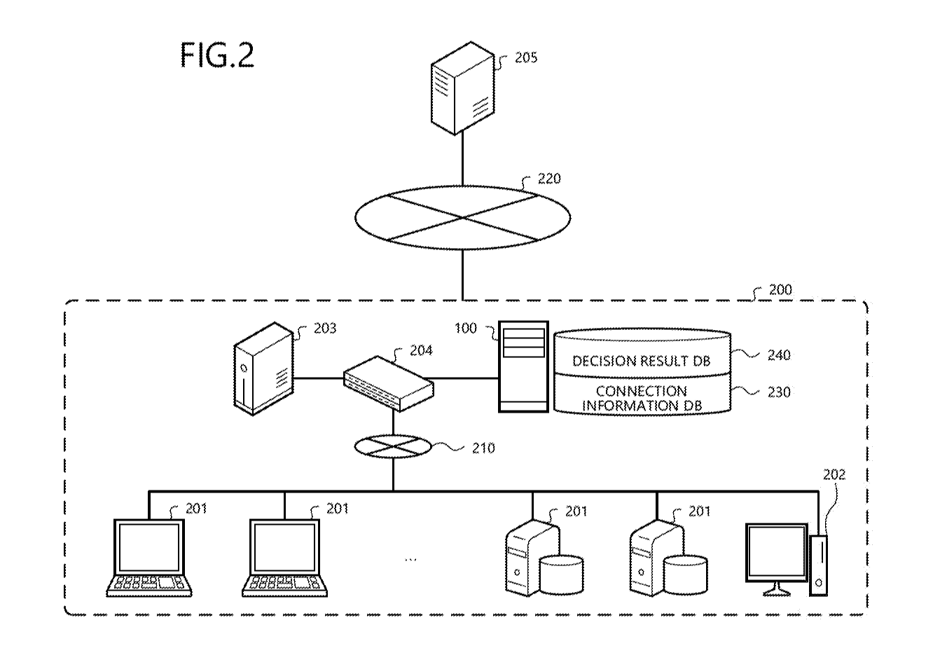

FIG. 2 is a diagram depicting an example of system configuration of the system 200. In FIG. 2, the system 200 includes the deciding apparatus 100, plural terminal apparatuses 201, a manager terminal apparatus 202, a firewall 203, and a proxy server 204. In the system 200, the deciding apparatus 100, the terminal apparatuses 201, the manager terminal apparatus 202, the firewall 203, and the proxy server 204 are connected through a wired or wireless internal network 210. The internal network 210, for example, is a local area network, (LAN), a wide area network (WAN), etc. Further, the system 200 is connected to an external computer (e.g., a C&C server 205) through a wired or wireless external network 220. The external network 220, for example, is the Internet, a LAN, a WAN, etc.

Here, the deciding apparatus 100 has a connection information database (DB) 230 and a decision result DB 240, and decides the legitimacy of a connection destination outside the system 200. The deciding apparatus 100, for example, is a server. In the description hereinafter, a connection destination outside the system 200 may be simply indicated as “connection destination”.

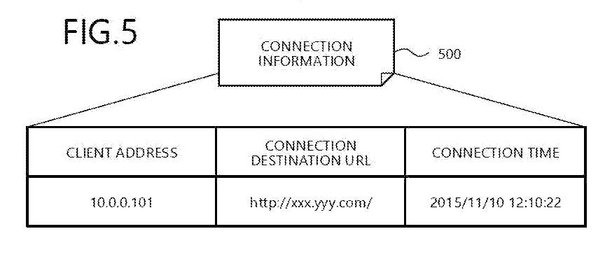

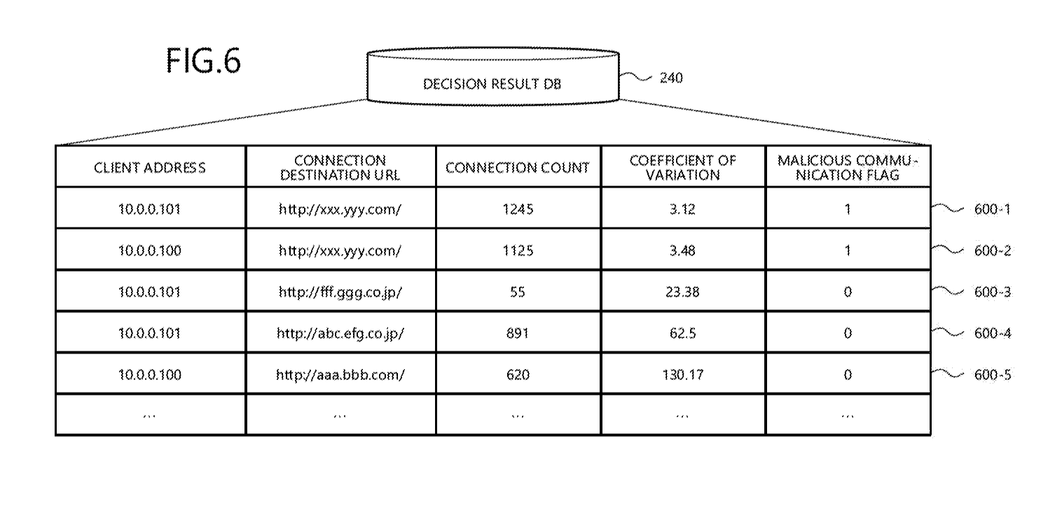

The connection information DB 230 stores connection information obtained from the proxy server 204. The connection information is information identifying connection timings of communication between a connection destination and a terminal apparatus 201 (or the manager terminal apparatus 202). A detailed example of the connection information will be described hereinafter with reference to FIG. 5. The storage unit 110 depicted in FIG. 1, for example, corresponds to the connection information DB 230. The decision result DB 240 stores decision results concerning the legitimacy of connection destinations. Contents stored by the decision result DB 240 will be described hereinafter with reference to FIG. 6.

A terminal apparatus 201, for example, is a computer such as a PC, a note PC, or a tablet PC used by an employee of an organization, a business server of the organization, etc. The organization, for example, is a government agency, a public service authority, a company, etc. The terminal apparatus 101 depicted in FIG. 1, for example, corresponds to the terminal apparatus 201. The manager terminal apparatus 202 is a computer such as a PC, a note PC, etc. used by a manager of the system 200.

The firewall 203, for example, is installed at the boundary of the system 200 and the external network 220, and is a computer for relaying and monitoring internal and external communication of the system 200 to protect the system from external attacks.

The proxy server 204 is a computer that accesses the external network 220 in place of the terminal apparatuses 201 or the manager terminal apparatus 202. In other words, communication from the terminal apparatuses 201 or the manager terminal apparatus 202 to a destination outside the system 200 is performed through the proxy server 204.

When detecting communication from the terminal apparatuses 201 (or the manager terminal apparatus 202) to a destination outside the system 200, the proxy server 204 transmits to the deciding apparatus 100, connection information indicating connection timings in the communication. Transmission timing of the connection information may be set arbitrarily.

For example, the proxy server 204 may transmit the connection information to the deciding apparatus 100 each time the proxy server 204 detects communication of the system 200 to an external destination. The proxy server 204, for example, may transmit connection information for an interval specified by the deciding apparatus 100, in response to a transmission request from the deciding apparatus 100.

The C&C server 205 is a server used by the attacker to send attack instructions to a malware infected computer. A computer (not depicted) used by the attacker is connected to the C&C server 205 through the external network 220. The connection destination 102 depicted in FIG. 1, for example, corresponds to the C&C server 205.

In the system 200, the deciding apparatus 100 may be installed near the proxy server 204 so that as far as practicable, no delay occurs when the connection information is obtained from the proxy server 204. Further, in the example depicted in FIG. 2, although the deciding apparatus 100, the firewall 203, and the proxy server 204 are each realized by independent computers, configuration is not limited hereto.

For example, the deciding apparatus 100 may be realized by the firewall 203 or the proxy server 204. Further, the firewall 203 and the proxy server 204 may be realized by a single computer. The manager terminal apparatus 202 may be any one of the plural terminal apparatuses 201.

As described above, when detecting communication from a terminal apparatus 201 to a counterpart outside the system 200, the proxy server 204 transmits to the deciding apparatus 100, connection information identifying connection timings in the communication. However, configuration is not limited hereto. For example, when communication from outside the system 200 to a terminal apparatus 201 (e.g., a response to a request from the terminal apparatus 201) is detected, the proxy server 204 may transmit to the deciding apparatus 100, connection information indicating connection timings in the concerned communication.

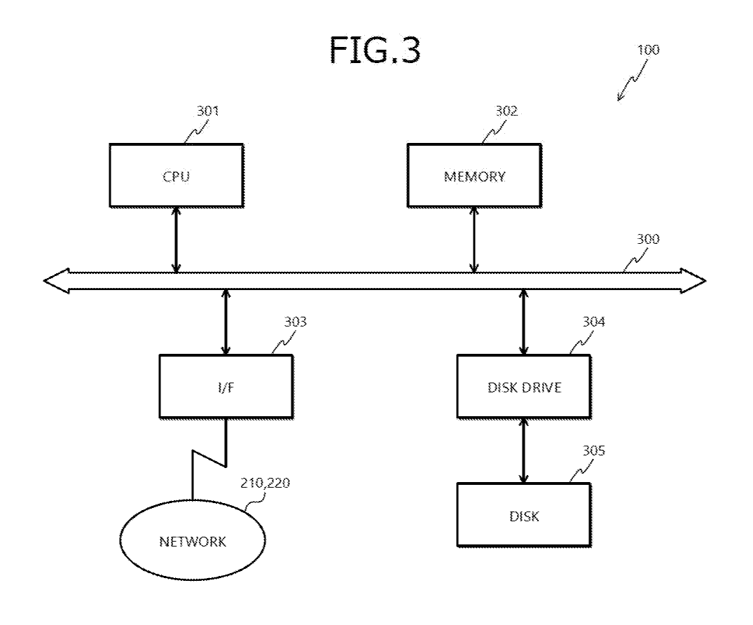

FIG. 3 is a block diagram depicting an example of hardware configuration of the deciding apparatus 100. In FIG. 3, the deciding apparatus 100 has a central processing unit (CPU) 301, a memory 302, an interface (I/F) 303, a disk drive 304, and a disk 305, respectively connected by a bus 300.

Here, the CPU 301 governs overall control of the deciding apparatus 100. The memory 302, for example, includes a read-only memory (ROM), a random access memory (RAM), and a flash ROM. In particular, for example, the flash ROM and ROM store various types of programs, and the RAM is used as a work area of the CPU 301. A program stored in the memory 302 is loaded onto the CPU 301, whereby a coded process is executed by the CPU 301.

The I/F 303 is connected to a network (e.g., the internal network 210, the external network 220) through a communications line and is connected to other apparatuses (e.g., the proxy server 204 depicted in FIG. 2) through the network. The I/F 303 administers an internal interface with the network and controls the input and output of data from other apparatuses. The I/F 303, for example, may be a modem, a LAN adapter, etc.

The disk drive 304, under the control of the CPU 301, controls the reading and writing of data with respect to the disk 305. The disk 305 stores data written thereto under the control of the disk drive 304. The disk 305, for example, may be a magnetic disk, an optical disk, etc.

In addition to the configuration above, the deciding apparatus 100, for example, may include a solid state drive (SSD), a keyboard, a mouse, a display, etc. Further, the firewall 203 and the proxy server 204 depicted in FIG. 2 may be realized by hardware configuration like that of the deciding apparatus 100.

An example of hardware configuration of the terminal apparatuses 201 and the manager terminal apparatus 202 depicted in FIG. 2 will be described. Here, the terminal apparatuses 201 and the manager terminal apparatus 202 will be denoted as “terminal apparatuses 201, etc.”

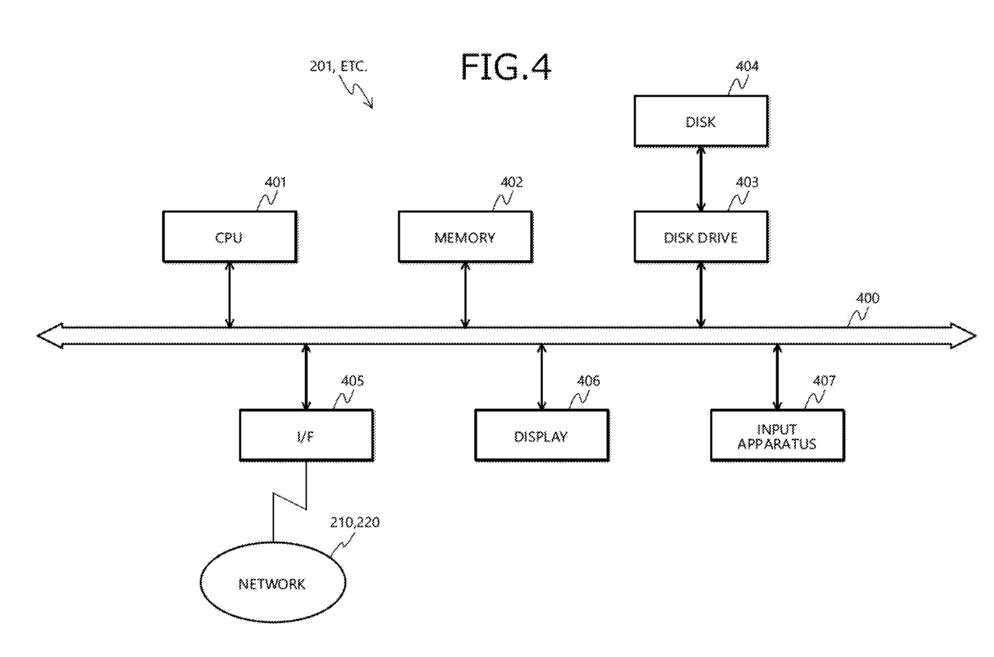

FIG. 4 is a block diagram depicting an example of hardware configuration of the terminal apparatuses 201, etc. In FIG. 4, the terminal apparatuses 201, etc. each includes a CPU 401, a memory 402, a disk drive 403, a disk 404, a I/F 405, a display 406, and an input apparatus 407, respectively connected by a bus 400.

Here, the CPU 401 governs overall control of terminal apparatuses 201, etc. The memory 402, for example, includes a ROM, a RAM and a flash ROM. In particular, for example, the flash ROM and ROM store various types of programs, and the RAM is used as a work area of the CPU 401. A program stored in the memory 402 is loaded onto the CPU 401, whereby a coded process is executed by the CPU 401.

The disk drive 403, under the control of the CPU 401, controls the reading and writing of data with respect to the disk 404. The disk 404 stores data written thereto under the control of the disk drive 403. The disk 404, for example, may be a magnetic disk, an optical disk, etc.

The I/F 405 is connected to a network (e.g., the internal network 210, the external network 220) through a communications line and is connected to other apparatuses (e.g., the proxy server 204 depicted in FIG. 2) through the network. The I/F 405 administers an internal interface with the network and controls the input and output of data from other apparatuses.

The display 406 displays data such as documents, images, functional information, etc., in addition to a cursor, icons, and toolboxes. The display 406, for example, may be a liquid crystal display, a cathode ray tube (CRT), etc.

The input apparatus 407 has keys for inputting characters, numerals, various instructions, etc., and inputs data. The input apparatus 407 may be a keyboard, a mouse, etc., or may be a touch panel input pad, a numeric pad, etc. The terminal apparatuses 201, etc., for example, may omit the disk drive 403, the disk 404.

A detailed example of the connection information transmitted from the proxy server 204 to the deciding apparatus 100 will be described.

FIG. 5 is a diagram depicting a detailed example of the connection information. In FIG. 5, connection information 500 includes client addresses, connection destination URLs, and connection times.

Here, a client address is an Internet protocol (IP) address of a terminal apparatus 201 (or the manager terminal apparatus 202) in the system 200. A connection destination URL is the URL of a connection destination. A connection time is information indicating a connection timing in the communication between a terminal apparatus 201 (or the manager terminal apparatus 202) and a connection destination, and for example, indicates the time when the proxy server 204 detects communication of the system 200 to an external destination.

The connection information 500 may indicate the connection time “2015/11/10 12:10:22” when communication was performed from a terminal apparatus 201 having a client address “10.0.0.101” to a connection destination having a connection destination URL “http://xxx.yyy.com/”.

Contents stored by the decision result DB 240 of the deciding apparatus 100 will be described. The decision result DB 240, for example, is realized by a storage apparatus of the deciding apparatus 100 depicted in FIG. 3 such as the memory 302, the disk 305, etc.

FIG. 6 is a diagram depicting one example of the contents stored by the decision result DB 240. In FIG. 6, the decision result DB 240 has fields for client addresses, connection destination URLs, connection counts, coefficients of variation, and malicious communication flags. Information is set into the respective fields, whereby decision result information (e.g., decision result information 600-1 to 600-5) is stored as records.

A client address is the IP address of a terminal apparatus 201 (or the manager terminal apparatus 202) in the system 200. A connection destination URL is the URL of a connection destination. A connection count is the number of times that a terminal apparatus 201 (or the manager terminal apparatus 202) and a connection destination are connected.

A coefficient of variation is a coefficient that varies corresponding to a statistical value indicating the extent of variation of connection intervals in the communication between the terminal apparatus 201 (or the manager terminal apparatus 202) and the connection destination. A malicious communication flag indicates a decision result of whether a connection destination is legitimate. Here, when the malicious communication flag is “0”, the connection destination is legitimate and when the malicious communication flag is “1”, the connection destination is not legitimate.

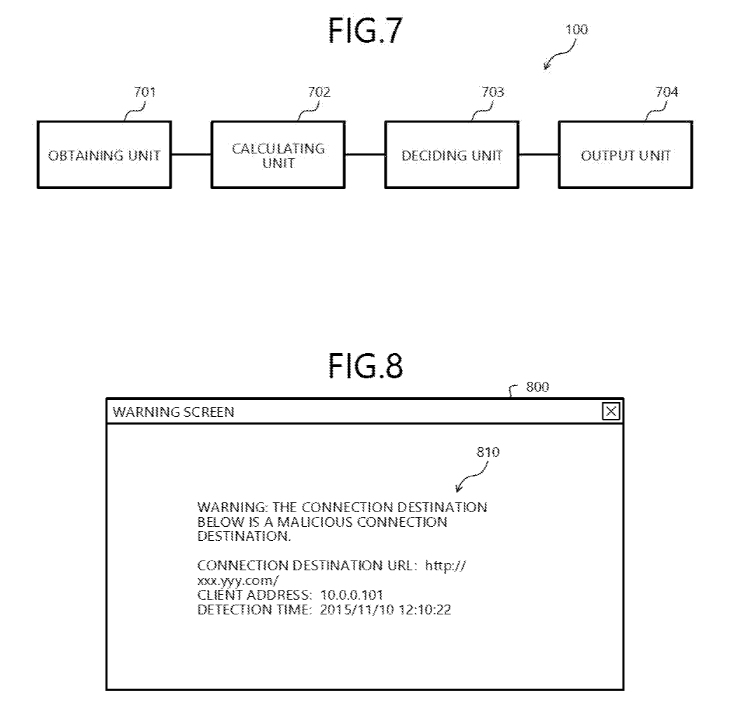

FIG. 7 is a block diagram depicting an example of a functional configuration of the deciding apparatus 100. In FIG. 7, the deciding apparatus 100 is configured to include an obtaining unit 701, a calculating unit 702, a deciding unit 703, and an output unit 704. The obtaining unit 701 to the output unit 704 are functions forming a control unit, and in particular, for example, are realized by executing on the CPU 301, a program stored in a storage apparatus such as the memory 302, the disk 305, etc. depicted in FIG. 3, or by the I/F 303. Process results of the functional units, for example, are stored to a storage apparatus such as the memory 302, the disk 305, etc.

The obtaining unit 701 obtains connection information. The connection information is information indicating connection timings in the communication between a terminal apparatus 201 (or the manager terminal apparatus 202) in the system 200 and a connection destination. The connection destination is a connection destination outside the system 200. In particular, for example, the obtaining unit 701 obtains the connection information by receiving the connection information from the proxy server 204.

The obtained connection information, for example, is stored to the connection information DB 230 (refer to FIG. 2). The connection information, for example, is transmitted from the proxy server 204 to the deciding apparatus 100 each time communication of the system 200 to an external destination is detected at the proxy server 204. However, the deciding apparatus 100, for example, may specify an interval and transmit a transmission request for the connection information to the proxy server 204. As a result, connection information may be obtained that indicates the connection timings in the communication performed within the specified interval.

The calculating unit 702, for each connection in the communication between a terminal apparatus 201 (or the manager terminal apparatus 202) and a connection destination, calculates an interval of the connection timings with respect to the previous connection, based on the obtained connection information. In particular, for example, the calculating unit 702, for each combination of a terminal apparatus 201 and connection destination, calculates connection intervals based on the connection information stored in the connection information DB 230.

In the description hereinafter, a combination of a terminal apparatus 201 (or the manager terminal apparatus 202) and a connection destination may be denoted as “pair P”. Further, a connection interval with respect to the previous connection in communication between a terminal apparatus 201 (or the manager terminal apparatus 202) and a connection destination may be denoted as simply “connection interval”.

In particular, for example, for each pair P, the calculating unit 702 obtains from the connection information DB 230, connection information for which the combination of the client address and the connection destination URL is the same as the pair P. For example, a combination of the terminal apparatus 201 having the client address “10.0.0.101” and the connection destination having the connection destination URL “http://xxx.yyy.com/” is assumed as the pair P.

In this case, the calculating unit 702 obtains from the connection information DB 230, connection information for which the client address is “10.0.0.101” and the connection destination URL is “http://xxx.yyy.com/”. The calculating unit 702 chronologically sorts the connection times of the obtained connection information and calculates each time interval between consecutive connection times.

As a result, a connection interval for each connection in the communication between the terminal apparatus 201 (or the manager terminal apparatus 202) and the connection destination may be calculated.

The calculating unit 702 may be configured to calculate the connection intervals based on the connection information that is stored in the connection information DB 230 and indicates the connection timing of each connection in the communication between the terminal apparatus 201 and connection destination, within a predetermined interval T. The predetermined interval T may be set arbitrarily.

For example, the length of the predetermined interval T may be set to be a length of a few hours to a few days. Further, the ending date/time of the predetermined interval T, for example, may be the current date/time, or set to the latest connection time among the connection times indicated by the connection information stored in the connection information DB 230. The starting date/time of the predetermined interval T may be a time point obtained by counting back for the interval length from the ending date/time of the predetermined interval T.

As a result, connection information indicating connection timings in the communication between the terminal apparatus 201 and the connection destination other than during the predetermined interval T may be excluded from processing. In other words, the connection information of a past interval may be arbitrarily specified for use in calculating a connection interval.

Further, the calculating unit 702 calculates, based on the calculated connection intervals, a statistical value indicating the extent of variation of the connection intervals. Here, a statistical value indicating the extent of variation of the connection intervals, for example, is the variance or standard deviation of the connection intervals. In particular, for example, the calculating unit 702 may use equation (1) to calculate for each pair P, a statistical value indicating the extent of variation of the connection intervals.

In equation (1), σₓₙ² is a value of variance of connection intervals (variance value). xᵢ is the connection interval between an i-th connection and an (i+1)-th connection in the communication between a terminal apparatus 201 (or the manager terminal apparatus 202) and a connection destination. μₙ is an average value of the connection intervals for n connections of the terminal apparatus 201 (or the manager terminal apparatus 202) and the connection destination, where n corresponds to the number of pieces of connection information concerning the pair P.

$${σ}_{xn}^{2} = \frac{1}{n} {\sum }_{i = 0}^{n - 1} {( {x}_{i} - {μ}_{n} )}^{2} \qquad ( 1 )$$

For example, a result of spectral analysis that assumes the connection intervals as frequency may be used as the statistical value indicating the extent of variation of the connection intervals.

The calculating unit 702 calculates the ratio of a statistical value indicating the extent of variation of the calculated connection intervals, to the average value of the calculated connection intervals. In particular, for example, for each pair P, the calculating unit 702 may use equation (2) to calculate the coefficient of variation CV. The coefficient of variation CV indicates the ratio of the standard deviation σₓₙ of the connection intervals to the average value μₙ of the connection intervals.

$$CV = \frac{\sqrt{{σ}_{xn}^{2}}}{{μ}_{n}} \times 100 \qquad ( 2 )$$

The coefficient of variation CV calculated for each pair P, for example, is stored to the decision result DB 240. In particular, for example, a connection count n, a coefficient of variation CV, and a malicious communication flag are stored associated with the client address and the connection destination URL of each pair P, whereby new decision result information is stored as a record in the decision result DB 240. In the initial state, the malicious communication flag is “0”.

The deciding unit 703 decides the legitimacy of the connection destination, based on the calculated connection intervals. In particular, for example, the deciding unit 703 decides the legitimacy of the connection destination for each pair P, based on a statistical value indicating the extent of variation of the calculated connection intervals.

Here, the smaller the statistical value indicating the extent of variation of the connection intervals is, it may said that communication between a terminal apparatus 201 (or the manager terminal apparatus 202) and a connection destination is at constant intervals. Therefore, for example, when the statistical value indicating the extent of variation of the calculated connection intervals is less than a predetermined threshold, the deciding unit 703 may decide that the connection destination is not legitimate.

The magnitude of the standard deviation or variance indicating the extent of variation of the connection intervals is dependent on the magnitude of the average value of the connection intervals. In other words, in deciding the legitimacy of the connection destination from the magnitude of the standard deviation or variance indicating the extent of variation of the connection intervals, the above threshold is set giving consideration to the average value of the connection intervals.

Therefore, the deciding unit 703 may decide the legitimacy of the connection destination based on the coefficient of variations CV calculated for the pairs P. In particular, for example, the deciding unit 703 refers to the decision result DB 240 and when the coefficient of variation CV is less than a threshold CVₜₕ, decides that the connection destination is not legitimate. On the other hand, when the coefficient of variation CV is equal to or greater than the threshold CVₜₕ, the deciding unit 703 decides that the connection destination is legitimate.

The threshold CVₜₕ may be set arbitrarily and, for example, is set to a value on the order of 50 to 100. Thus, by dividing the statistical value indicating the extent of variation of the connection intervals by the average value of the connection intervals to perform normalization, for example, even when the average value of the connection intervals varies according to the connection destination, the legitimacy of the connection destination may be decided using the threshold CVₜₕ.

The deciding unit 703 may decide the legitimacy of the connection destination, when the connection count n in the communication between a terminal apparatus 201 (or the manager terminal apparatus 202) and a connection destination becomes greater than a predetermined count N. The connection count n corresponds to the number of pieces of connection information used for calculation of the connection intervals. The predetermined count N may be set arbitrarily and, for example, is set to a value on the order of 70 to 100.

As a result, configuration may be such that the legitimacy of a connection destination is not decided until connection information for a number of connections (sample count) enabling a reliable value to be obtained as a statistical value is collected.

Decision results are associated with the client address and connection destination URL of each pair P and stored in the decision result DB 240. For example, when a connection destination is decided to not be legitimate, the malicious communication flag indicating decision result information is set to “1”. On the other hand, when a connection destination is decided to be legitimate, the malicious communication flag indicating decision result information is set to “0”.

Here, decision result information 600-1, 600-3 depicted in FIG. 6 will be taken as an example to describe an example of setting the malicious communication flag. In the present example, the threshold CVₜₕ is assumed to be “CVₜₕ=50” and the predetermined count N is assumed to be “N=100”. Further, when the connection count n is greater than the predetermined count N, the deciding unit 703 is assumed to decide the legitimacy of the connection destination.

The connection count n of the decision result information 600-1 is “n=1245”, which is greater than the predetermined count N. Further, the coefficient of variation CV of the decision result information 600-1 is “CV=3.12”, which is less than the threshold CVₜₕ. In this case, the deciding unit 703 decides that the connection destination of the connection destination URL in the decision result information 600-1 is not legitimate. Therefore, the malicious communication flag of the decision result information 600-1 is set to “1”.

The connection count n of the decision result information 600-3 is “n=55”, which is equal to or less than the predetermined count N. In this case, since the decision concerning the legitimacy of the connection destination of the connection destination URL in the decision result information 600-3 is not performed, the malicious communication flag of the decision result information 600-3 remains as “O0”. Further, configuration may be such that when the connection count n is equal to or less than the predetermined count N, the coefficient of variation CV is not calculated.

The output unit 704 outputs the decision result. The form of output of the output unit 704, for example, may be transmission to an external apparatus by the I/F 303, storage to a storage apparatus such as the memory 302 and the disk 305, display on a non-depicted display, print out at a non-depicted printer, etc.

In particular, for example, when the connection destination is decided to not be legitimate, the output unit 704 may output to the manager terminal apparatus 202, warning information that includes identification information of the terminal apparatus 201 and identification information of the connection destination. The identification information of the terminal apparatus 201, for example, is the client address. The identification information of the connection destination, for example, is the connection destination URL.

As a result, the manager of the system 200 may be notified of the detection of a malicious connection destination. An example of a warning screen that includes warning information and is displayed on the display 406 of the manager terminal apparatus 202 will be described hereinafter with reference to FIG. 8.

The output unit 704, for example, may refer to the decision result DB 240 to transmit a decision result list to the manager terminal apparatus 202. The decision result list, for example, is a list of decision results associated with the client address, the connection destination URL, and the malicious communication flag of each of the pairs P.

As a result, at the manager terminal apparatus 202, the decision result of the legitimacy of a connection destination connected to by a terminal apparatus 201 may be confirmed. The decision result list, for example, may be transmitted to the manager terminal apparatus 202 in response to a confirmation request from the manager.

The calculating unit 702 may use condition formulas representing relations of the extent to which a connection destination is an invalid connection destination and statistical values indicating the extent of variation of the connection intervals to calculate the degree of suspiciousness of a connection destination. The degree of suspiciousness of a connection destination is a value indicating the extent to which a connection destination is an invalid connection destination. Further, when the connection count n is greater than the predetermined count N, the calculating unit 702 may calculate a value for the suspiciousness of the connection destination.

In particular, for example, the calculating unit 702 may use equations (3) to (5) to calculate the degree of suspiciousness of a connection destination, where, d is the degree of suspiciousness of the connection destination. CV is the coefficient of variation and, for example, is identified from the decision result DB 240. Further, the smallest value of the degree of suspiciousness d is “0” [symbol] , and the greatest value is “1”. The closer the degree of suspiciousness d is to “1”, the greater the extent to which a connection destination is an invalid connection destination is.

If CV<10 [symbol] d=1.0 (3)

If 10≦CV≦100 [symbol] d=f(CV)=−CV/90+10/9 (4)

If CV>100 [symbol] d=0.0 (5)

Here, the decision result information 600-4 depicted in FIG. 6 will be taken as an example to describe a calculation example of the degree of suspiciousness d. The coefficient of variation CV of the decision result information 600-4 is “62.5”. In this case, the calculating unit 702 uses equation (4) to calculate the degree of suspiciousness d of a connection destination. Here, the degree of suspiciousness d of a connection destination is “0.4”.

The output unit 704 outputs the calculated degree of suspiciousness of a connection destination. In particular, for example, the output unit 704 may output to the manager terminal apparatus 202, a degree of suspiciousness list of degree of suspiciousness information that associates the client address of the terminal apparatus 201, the connection destination URL of the connection destination, and the degree of suspiciousness d of the connection destination.

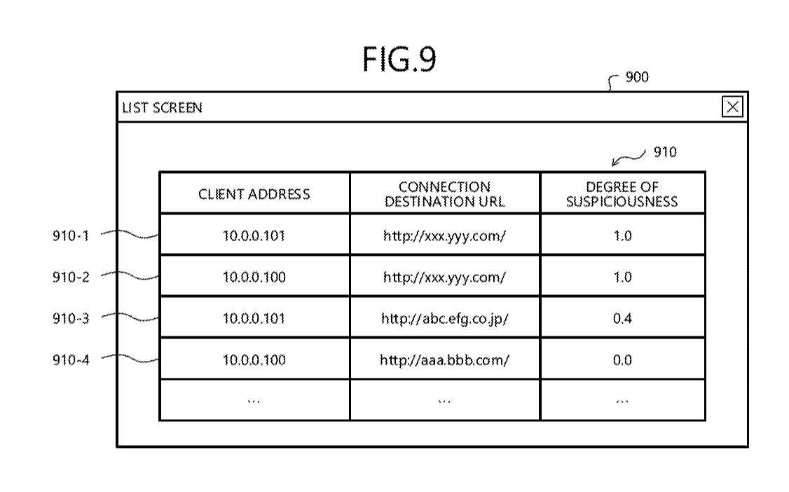

As a result, at the manager terminal apparatus 202, the degree of suspiciousness d of a connection destination connected to by a terminal apparatus 201 may be confirmed. An example of a list screen that includes the degree of suspiciousness list and is displayed on the display 406 of the manager terminal apparatus 202 will be described with reference to FIG. 9.

An example of a warning screen that includes warning information and is displayed on the display 406 of the manager terminal apparatus 202 will be described.

FIG. 8 is a diagram depicting an example of a warning screen. In FIG. 8, a warning screen 800 displays warning information 810. The warning information 810 indicates the connection destination URL, the client address, and a detection time. The connection destination URL is the URL of a connection destination decided to not be legitimate. The client address is the IP address of the terminal apparatus 201 that is the connection source.

The detection time is the time when the connection destination is decided to not be legitimate. For example, the ending date/time of the predetermined interval T may be set as the detection time. Further, for example, the connection time when the terminal apparatus 201 and the connection destination are first connected may be set as detection time.

Through the warning screen 800, the manager of the system 200 may determine that the connection destination URL “http://xxx.yyy.com/” has a high possibility of being a malicious connection destination. Further, the manager may determine that the terminal apparatus 201 of the client address “10.0.0.101” has a high possibility of being infected by malware.

An example of a list screen that includes the degree of suspiciousness list and is displayed on the display 406 of the manager terminal apparatus 202 will be described.

FIG. 9 is a diagram depicting an example of a list screen. In FIG. 9, a list screen 900 displays a degree of suspiciousness list 910. The degree of suspiciousness list 910 is information indicating a list of degree of suspiciousness information (e.g., degree of suspiciousness information 910-1 to 910-4) associating the connection destination URL, the client address, and the degree of suspiciousness.

The connection destination URL is the URL of the connection destination. The client address is the IP address of the terminal apparatus 201 that is the connection source. The degree of suspiciousness is a value indicating the extent to which the connection destination is an invalid connection destination. The degree of suspiciousness list 910 may include information identifying the time (e.g., the ending date/time of the predetermined interval T) when the degree of suspiciousness was calculated.

Through the list screen 900, the manager of the system 200 may grasp the extent to which the connection destination is an invalid connection destination. As a result, for example, even concerning connection destinations that may not be detected by the threshold comparison decision, investigation is possible when the degree of suspiciousness is relatively high, enabling missed detection of a malicious communication counterpart to be prevented. Further, with consideration of human resources and time consumed for security measures, connection destinations to be investigated among multiple connection destinations may be easily narrowed down.

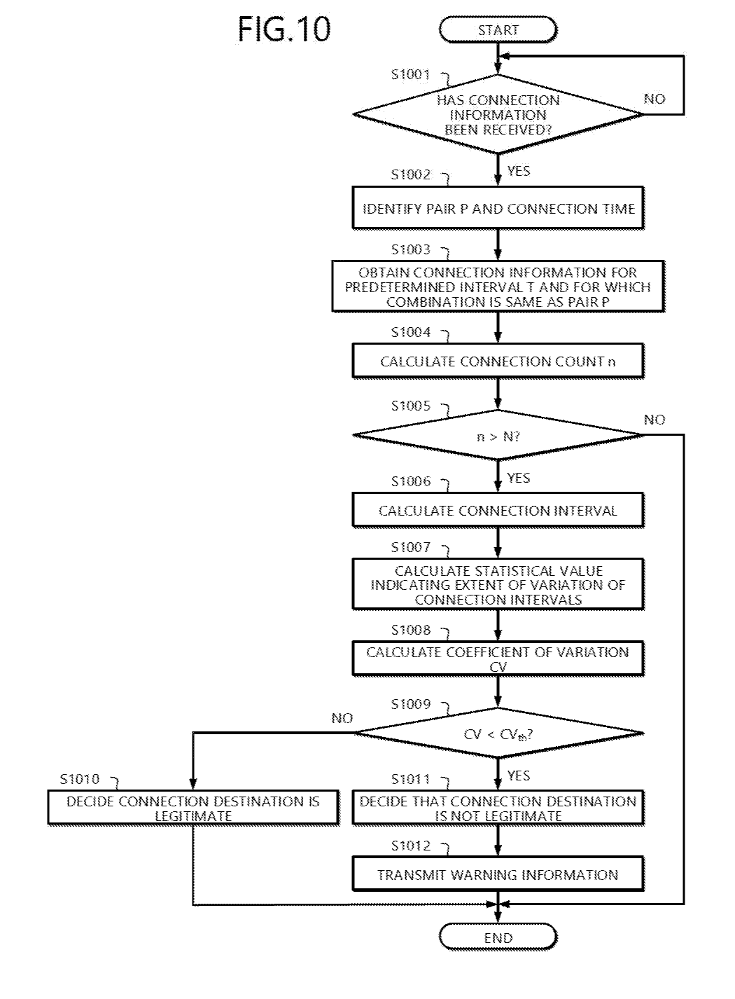

A procedure of a deciding process by the deciding apparatus 100 will be described. A procedure of a first deciding process executed each time connection information is received from the proxy server 204 will be described with reference to FIG. 10.

FIG. 10 is a flowchart depicting an example of a procedure of the first deciding process by the deciding apparatus 100. In the flowchart depicted in FIG. 10, the deciding apparatus 100 determines whether connection information has been received from the proxy server 204 (step S1001). Here, the deciding apparatus 100 stands by for receipt of connection information (step S1001: NO).

When connection information has been received (step S1001: YES), the deciding apparatus 100 refers to the received connection information and identifies the pair P of the client address and the connection destination URL, and the connection time (step S1002). The received connection information is stored to the connection information DB 230.

The deciding apparatus 100 obtains from the connection information DB 230, the connection information for which the connection times are within the predetermined interval T, among the connection information for which the combination of the client address and the connection destination URL is the same as that of the identified pair P (step S1003). Here, the starting date/time of the predetermined interval T is assumed to be the time point obtained by counting back 24 hours from the identified connection time, and the ending date/time of the predetermined interval T is assumed to be the identified connection time.

The deciding apparatus 100 calculates the connection count n by counting the pieces of obtained connection information (step S1004). The calculated connection count n is set in decision result information corresponding to the pair P in the decision result DB 240. The deciding apparatus 100 determines whether the calculated connection count n is greater than the predetermined count N (step S1005).

If the connection count n is equal to or less than the predetermined count N (step S1005: NO), the deciding apparatus 100 ends a series of operations according to the flowchart. On the other hand, if the connection count n is greater than the predetermined count N (step S1005: YES), the deciding apparatus 100 calculates based on the obtained connection information, a connection interval of each connection in the communication between the terminal apparatus 201 and the connection destination (step S1006).

The deciding apparatus 100 calculates based on the calculated connection intervals, a statistical value indicating the extent of variation of the connection intervals (step S1007). The deciding apparatus 100 calculates the coefficient of variation CV indicating the ratio of the statistical value indicating the extent of variation of the connection intervals, to the average value of the connection intervals (step S1008). The calculated coefficient of variation CV is set in decision result information corresponding to the pair P in the decision result DB 240.

The deciding apparatus 100 determines whether the calculated coefficient of variation CV is less than the threshold CVₜₕ (step S1009). If the coefficient of variation CV is equal to or greater than the threshold CVₜₕ(step S1009: NO), the deciding apparatus 100 decides that the connection destination is legitimate (step S1010), and ends a series of operations according to the flowchart. When the connection destination is decided to be legitimate, the malicious communication flag of the decision result information corresponding to the pair P in the decision result DB 240 is set to “0”.

On the other hand, when the coefficient of variation CV is less than the threshold CVₜₕ (step S1009: YES), the deciding apparatus 100 decides that the connection destination is not legitimate (step S1011). When the connection destination is decided to not be legitimate, the malicious communication flag of the decision result information corresponding to the pair P in the decision result DB 240 is set to “1”.

The deciding apparatus 100 transmits to the manager terminal apparatus 202, warning information that includes the client address and connection destination URL of the pair P (step S1012), and ends a series of operations according to the flowchart.

As a result, each time communication from a terminal apparatus 201 in the system 200 to an external connection destination is detected, connection information of the predetermined interval T may be used to decide the legitimacy of the connection destination. Therefore, for example, in the initial stage from infection by malware until receipt of an instruction from the attacker, malicious communication with the C&C server 205 may be detected.

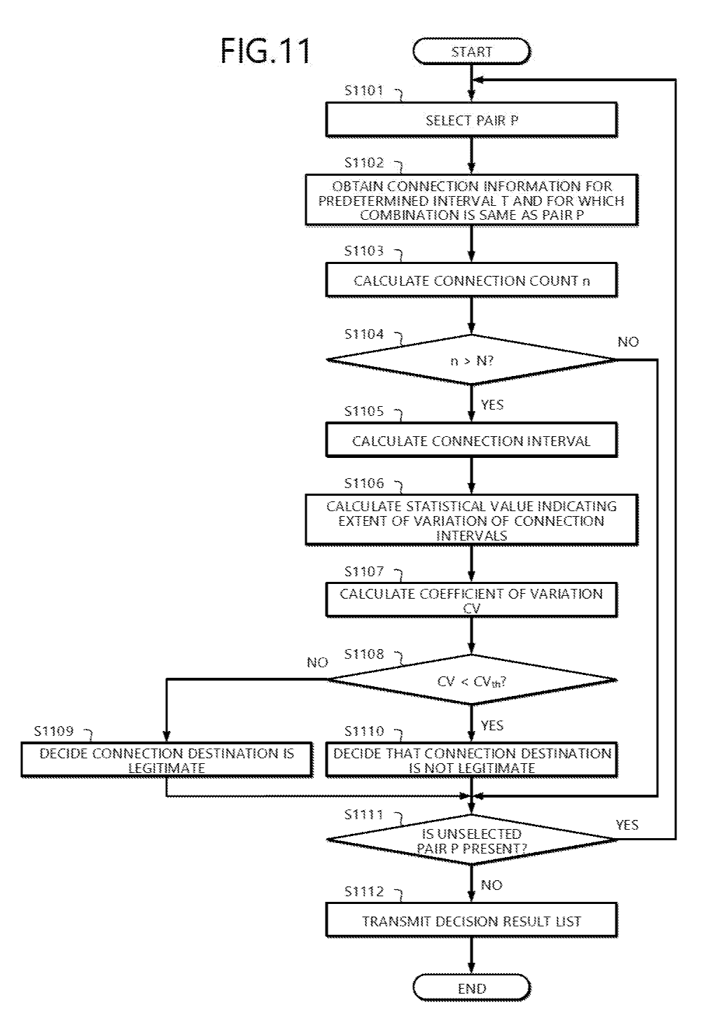

A procedure of a second deciding process executed in response to an instruction from the manager of the system, or on a predetermined date and time (e.g., daily at 0:00) will be described with reference to FIG. 11. An instruction from the manager, for example, is input at the manager terminal apparatus 202 and transmitted to the deciding apparatus 100.

FIG. 11 is a flowchart depicting an example of a procedure of the second deciding process by the deciding apparatus 100. In the flowchart of FIG. 11, the deciding apparatus 100 refers to the connection information DB 230 and selects an unselected pair P among pairs P of a terminal apparatus 201 and a connection destination (step S1101).

The deciding apparatus 100 obtains from the connection information DB 230, the connection information for which the connection time is within the predetermined interval T, among the connection information for which the combination of the client address and the connection destination URL is the same as that of an identified pair P (step S1102). Here, the starting date/time of the predetermined interval T is assumed to be a time point obtained by counting back 24 hours from an identified connection time, and the ending date/time of the predetermined interval T is assumed to be the identified connection time.

The deciding apparatus 100 calculates the connection count n by counting the pieces of obtained connection information (step S1103). The calculated connection count n is set in decision result information corresponding to the pair P in the decision result DB 240. The deciding apparatus 100 determines whether the calculated connection count n is greater than the predetermined count N (step S1104).

If the connection count n is equal to or less than the predetermined count N (step S1104: NO), the deciding apparatus 100 transitions to step S1111. On the other hand, if the connection count n is greater than the predetermined count N (step S1104: YES), the deciding apparatus 100 calculates based on the obtained connection information, a connection interval for each connection in the communication between the termination apparatus 201 and the connection destination (step S1105).

The deciding apparatus 100 calculates based on the calculated connection intervals, a statistical value indicating the extent of variation of the connection intervals (step S1106). The deciding apparatus 100 calculates the coefficient of variation CV indicating the ratio of the statistical value indicating the extent of variation of the connection intervals, to the average value of the connection intervals (step S1107). The calculated coefficient of variation CV is set in decision result information corresponding to the pair P in the decision result DB 240.

The deciding apparatus 100 determines whether the calculated coefficient of variation CV is less than the threshold CVₜₕ (step S1108). If the coefficient of variation CV is equal to or greater than the threshold CVₜₕ(step S1108: NO), the deciding apparatus 100 decides that the connection destination is legitimate (step S1109), and transitions to step S1111. When the connection destination is decided to be legitimate, the malicious communication flag of the decision result information corresponding to the pair P in the decision result DB 240 is set to “0”.

On the other hand, if the coefficient of variation CV is less than the threshold CVₜₕ (step S1108: YES), the deciding apparatus 100 decides that the connection destination is not legitimate (step S1110). When the connection destination is decided to not be legitimate, the malicious communication flag of the decision result information corresponding to the pair P in the decision result DB 240 is set to “1”.

The deciding apparatus 100 refers to the connection information DB 230 and determines whether an unselected pair P among the pairs P of a terminal apparatus 201 and a connection destination is present (step S1111). If an unselected pair P is present (step S1111: YES), the deciding apparatus 100 returns to step S1101.

On the other hand, if no unselected pair P is present (step S1111: NO), the deciding apparatus 100 transmits to the manager terminal apparatus 202, a decision result list indicating a list of decision results associated with the client address, the connection destination URL, and the malicious communication flag of each of the pairs (step S1112), and ends a series of operations according to the flowchart.

As a result, in response to an instruction from the manager or on a predetermined date and time, the legitimacy of the connection destination may be decided for each pair P, using connection information of the predetermined interval T.

As described, the deciding apparatus 100 according to the embodiment enables connection information identifying connection timings in communication between a terminal apparatus 201 (or the manager terminal apparatus 202) and a connection destination to be obtained and stored to the connection information DB 230. Further, the deciding apparatus 100 enables reference to the connection information DB 230 and calculation of a connection interval for each connection in the communication between a terminal apparatus 201 and a connection destination. The deciding apparatus 100 enables calculation of a statistical value indicating the extent of variation of the calculated connection intervals and further enables the legitimacy of the connection destination to be decided based on the calculated statistical value.

In particular, for example, the deciding apparatus 100 calculates the coefficient of variation CV based on the average value of the calculated connection intervals and a statistical value indicating the extent of variation of the calculated connection intervals. The coefficient of variation CV indicates a ratio of the statistical value indicating the extent of variation of the calculated connection intervals to the average value of the connection intervals. The deciding apparatus 100 decides that the connection destination is not legitimate when the calculated coefficient of variation CV is less than the threshold CVₜₕ. On the other hand, when the coefficient of variation CV is equal to or greater than the threshold CVₜₕ, the deciding apparatus 100 decides that the connection destination is legitimate.

As a result, a connection destination communicating with a terminal apparatus 201 in the system 200 at substantially constant intervals may be decided to be a connection destination that is not legitimate. Therefore, for example, in the initial stage until receipt of an instruction from the attacker, the C&C server 205 performing malicious communication with malware may be detected. When a connection destination is decided to not be legitimate, the terminal apparatus 201 that is the connection source may be identified as a computer having a high possibility of being infected by malware. Use of the coefficient of variation CV that is normalized by dividing the statistical value indicating the extent of variation of the connection intervals by the average value of the connection intervals, for example, enables the legitimacy of the connection destination to be decided using the threshold CVₜₕ even when the average value of the connection intervals varies according to connection destination.

The deciding apparatus 100 enables the connection information DB 230 to be referenced and for each pair P, calculation of a connection interval for each connection in the communication between the terminal apparatus 201 and the connection destination. The deciding apparatus 100 enables for each pair P, calculation of a statistical value indicating the extent of variation of the calculated connection intervals and the legitimacy of the connection destination to be decided based on the calculated statistical value. As a result, for each pair P of a terminal apparatus 201 and a connection destination, the legitimacy of the connection destination may be decided.

The deciding apparatus 100 enables the legitimacy of the connection destination to be decided when the connection count n in the communication between the terminal apparatus 201 and the connection destination is greater than the predetermined count N. As a result, configuration may be such that the legitimacy of the connection destination is not decided until connection information for a number of connections (sample count) enabling a reliable value to be obtained as a statistical value is collected.

The deciding apparatus 100 enables connection intervals to be calculated based on connection information that is stored in the connection information DB 230 and identifies a connection timing of each connection in the communication between a terminal apparatus 201 and a connection destination, within the predetermined interval T. As a result, the connection information of a past interval may be arbitrarily specified for use in calculating a connection interval. Further, by narrowing down the intervals to a certain extent, characteristics that appear in the initial stage from infection by malware until receipt of an instruction from the attacker may be captured accurately.

The deciding apparatus 100 enables warning information that includes the client address of the terminal apparatus 201 and the connection destination URL of the connection destination to be output when the connection destination is decided to not be legitimate. As a result, for example, the manager of the system 200 may be notified that a malicious connection destination has been detected.

The deciding apparatus 100 enables the degree of suspiciousness of a connection destination to be calculated using condition formulas (e.g., equations (3) to (5)) representing relations of the extent to which a connection destination is an invalid connection destination and a statistical value indicating the extent of variation of the connection intervals. The deciding apparatus 100 enables the calculated degree of suspiciousness of a connection destination to be output. As a result, for example, the manager of the system 200 is presented with the extent to which a connection destination is an invalid connection destination to enable the manager to determine a malicious connection destination.

Thus, the deciding apparatus 100 detects a sign of an advanced targeted attack, enabling a malicious connection destination and malware infected terminal apparatus 201 to be discovered at an early stage, whereby malicious communication may be blocked and the leakage of confidential information by an advanced targeted attack may be prevented.

The deciding method described in the present embodiment may be implemented by executing a prepared program on a computer such as a personal computer and a workstation. The deciding program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

However, with the conventional techniques above, detection of a connection destination performing malicious communication is difficult. For example, in the method of monitoring communication from the system to an external counterpart and comparing the communication counterpart with a list of communication counterparts known as C&C servers, communication to a C&C server not on the list cannot be detected.

According to one aspect of the present invention, detection of a connection destination of malicious communication becomes possible.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory, computer-readable recording medium storing therein a deciding program that causes a computer to execute a process comprising:
storing connection information to a storage apparatus, the connection information including each of a plurality of connection timings, respectively, of a plurality of connections in communication between a terminal apparatus and a connection destination;
calculating a plurality of connection intervals for each of the plurality of connections based on the connection information, the plurality of connection intervals being intervals of the plurality of connection timings with respect to previous connections, respectively; and
deciding legitimacy of the connection destination based on the plurality of connection intervals.

2. The recording medium according to claim 1, wherein
the deciding includes deciding that the connection destination is not legitimate, when variation of the plurality of connection intervals is less than a predetermined reference.

3. The recording medium according to claim 1, further comprising
calculating based on the plurality of connection intervals, a statistical value indicating an extent of variation of the plurality of connection intervals, wherein
the deciding includes deciding the legitimacy of the connection destination based on the statistical value.

4. The recording medium according to claim 3, wherein
the deciding includes deciding that the connection destination is not legitimate, when a ratio of the statistical value to an average value of the plurality of connection intervals is less than a threshold.

5. The recording medium according to claim 1, wherein
the storage apparatus stores therein for a combination of a terminal apparatus and a connection destination, the connection information including the each of the plurality of connection timings, respectively, of the plurality of connections in the communication between the terminal apparatus and the connection destination,
the calculating the plurality of connection intervals includes calculating a connection interval of the plurality of connection intervals, for the combination, based on the connection information stored in the storage apparatus, and
the deciding includes deciding the legitimacy of the connection destination for the combination, based on the plurality of connection intervals.

6. The recording medium according to claim 1, wherein
the deciding includes deciding the legitimacy of the connection destination when a connection count in the communication between the terminal apparatus and the connection destination is greater than a predetermined count.

7. The recording medium according to claim 1, wherein
the calculating the plurality of connection intervals includes calculating the plurality of connection intervals based on the connection information that is stored in the storage apparatus and includes the each of the plurality of connection timings, respectively, of the plurality of connections within a predetermined interval of the communication between the terminal apparatus and the connection destination.

8. The recording medium according to claim 1, further comprising
outputting warning information that includes identification information of the terminal apparatus and identification information of the connection destination, when the connection destination is decided to not be legitimate.

9. The recording medium according to claim 3, further comprising:
calculating a value indicating an extent to which the connection destination is an invalid connection destination, the value being calculated using a condition formula representing a relation of the statistical value and the extent to which the connection destination is an invalid connection destination; and
outputting the calculated value indicating the extent to which the connection destination is an invalid connection destination.

10. A deciding method comprising:
storing, by a computer to a storage apparatus, connection information including each of a plurality of connection timings, respectively, of a plurality of connections in communication between a terminal apparatus and a connection destination;
calculating, by the computer, a plurality of connection intervals for each of the plurality of connections based on the connection information, the plurality of connection intervals being intervals of the plurality of connection timings with respect to previous connections, respectively; and
deciding, by the computer, legitimacy of the connection destination based on the plurality of connection intervals.

11. A deciding apparatus comprising:
a memory configured to store therein connection information including each of a plurality of connection timings, respectively, of a plurality of connections in communication between a terminal apparatus and a connection destination; and
a processor coupled to the memory, the processor configured to:
calculate a plurality of connection intervals for each of the plurality of connections based on the connection information, the plurality of connection intervals being intervals of the plurality of connection timings with respect to previous connections, respectively, and
decide legitimacy of the connection destination based on the plurality of connection intervals.
